(19) United States
(12) Patent Application Publication
(10) Pub. No.: US 2006/0262123 A1
(43) Pub. Date: Nov. 23, 2006

(54) Integrated circuit incorporated into image processing system

(76) Inventor: Mitsushige Baba, Tokyo (JP)

Correspondence Address: DICKSTEIN SHAPIRO LLP, 1825 EYE STREET NW, Washington, DC, 20006-5403, US

(21) Appl. No.: 11/436,527

(22) Filed: May 19, 2006

(30) Foreign Application Priority Data
May 20, 2005 (JP) 2005-148174

(51) Int. Cl. G06T 1/00

(52) U.S. Cl. 345/501

(57) ABSTRACT

A semiconductor integrated circuit configured to perform image processing includes a data processing section and a process control section which is provided with an image data storage means. The process control section is configured to determine enabling/disabling of an image processing function of the data processing section. By disabling the image processing function, image data from an image sensor are transmitted to an image data receiving section. By enabling the image processing function, prefixed image data are transmitted as alternative image data. With the present device configuration, image data acquired by an image sensor are transmitted to personal computer not only directly as acquired, but also as prefixed image data as a result of suitable processing, which can be utilized as a substitute for image data inappropriate for normal image display.

### CLAIM FOR PRIORITY

This patent application claims priority to and is based on Japanese Patent Application No. JP2005-148174 filed on May 20, 2005 in the Japan Patent Office, the entire contents of which are incorporated by reference herein.

### FIELD OF THE INVENTION

The invention generally relates to semiconductor integrated circuits, and more specifically to an integrated circuit incorporated into an image processor such as a video camera system using a CMOS or CCD image sensor connected to a host machine by way of a high speed bus.

### BACKGROUND OF THE INVENTION

A web camera has recently come on the market, which is a real time camera or a kind of video camera, whose images can be accessed using a host computer with relative ease through connection with a USB interface.

The web camera typically includes a lens, an image sensor, and some support electronics. Image sensors can be CMOS or CCD, and support electronics can be used for reading an image from the sensor and transmitting it to the host computer, such as a PC (personal computer), over a USB interface.

As to the use of the web camera, television conference (videoconference) systems have been realized in more areas with rather simple uses of a web camera without providing an elaborated system, owning largely to proliferation of suitable interfaces and applications together with increased video quality.

It is noticeable in the recent trends that a simple and easy videoconference system has become available provided with one PC machine per head in a workplace and at least one machine a household, and that videoconferences may be called any time on demand particularly during activities in business environments.

In such circumstance, however, a conference may be called regardless of the conditions of each individual, as distinct from the assembly type conference in the past. Similarly, when the system is utilized as a substitute for videophone in the home, a video communication may start regardless of the personal conditions.

This gives rise to the case in which particular image data such as, for example, unwanted personal image (or data) may desirably be prevented from the transmission.

FIG. 6 is a block diagram illustrating the internal configuration of a known integrated circuit 100 incorporated into an image processor.

Referring to FIG. 6, the integrated circuit 100 is configured to acquire image data by an image data receiving section 101 according to an interface protocol with the CMOS/CCD sensor 110, store the thus acquired image data in a buffer 102 serving as a buffering mechanism for a host bus 111, and output the stored data through a bus protocol generating section 103 to a host machine 112 according to a connection protocol by way of the host bus 111.

On the other hand, a method to address a similar situation as above mentioned has been disclosed in a video conference system. That is, in order to prevent parties from monitoring the area other than a presently concerned party, a suitable mask process is implemented by the system with respect to acquired image data (for example, Japanese Laid-Open Patent Application No. 8-51611).

However, a difficulty with such method is that specific software for image processing has to be prepared in order to suitably adapt the system to a rather simple conference system.

In addition, the compilation of suitable applications may become more complicated, since additional steps have to be incorporated into the conventional image data process flow which ranges over image data acquisition hardware, operation system, image processing, and conference specific applications.

It is therefore desirable to provide an image processing system having improved capabilities suitable for videoconferencing and hardware useful for the system, including semiconductor devices, incorporated into the system hardware.

### BRIEF SUMMARY OF THE INVENTION

Accordingly, it is an object of the invention to provide a semiconductor integrated circuit having most, if not all, of the advantages and features of similarly employed integrated circuits, while reducing or eliminating many of the aforementioned disadvantages.

It is another object to provide a semiconductor integrated circuit configured to perform image processing, capable of making alterations to image data without affecting basic flow of image processing, and achieving such process with relative ease with an image processing system including an integrated circuit without substantially affecting the conventional image data process flow.

The following description is a synopsis of only selected features and attributes of the present invention. A more complete description thereof is found below in the section entitled “Description of the Preferred Embodiments.”

The above and other objects of the invention are achieved by providing a semiconductor integrated circuit configured to convert input image data according to a predetermined protocol of an output bus and output image data thus converted, comprising
a data processing section configured to perform predetermined processing with respect to input image data to subsequently output resulting image data; and
a process control section configured to control, according to a control signal input from outside, such that the data processing section controls an output process of the processed image data; in which the process control section instructs, in the case when the output process of the processed image data is disabled, the data processing section to output prefixed image data. In addition, the predetermined protocol is a USB interface.

In another aspect, the process control section is provided with an image data storage means to store image data set from outside, in which the process control section instructs, in the case when the output process of the processed image data is disabled, the data processing section to output image data stored in the image data storage means.

With this device configuration and capability of the integrated circuit of the invention, the enabling or disabling control of displaying image data and accordingly desirable performance of image data display become feasible with relative ease, since it is configured for the process control section to be capable of instructing the data processing section to output prefixed image data when normal image data output process is disabled.

In addition, the abovementioned process can be performed without substantially affecting the basic image data process flow and without decreasing the speed of image data processing.

These and other features and advantages of the invention will be more clearly seen from the following detailed description of the invention which is provided in connection with the accompanying drawings.

### BRIEF DESCRIPTION OF THE DRAWINGS

FIG. 1 is a diagrammatic block diagram illustrating the configuration of an image processing system incorporating an integrated circuit according to an exemplary embodiment of the invention;

FIG. 2 is a block diagram illustrating the internal configuration of the integrated circuit of FIG. 1;

FIG. 3 is a block diagram illustrating an internal configuration of the data processing section of FIG. 1, in which AND circuits are included;

FIG. 4 is a block diagram illustrating another internal configuration of the data processing section, in which NOR circuits are included in place of the AND circuits of FIG. 3;

FIG. 5 is a block diagram illustrating still another internal configuration of the data processing section, in which multiplexers are included, and the process setting section includes a gate enabling register and a setting value register; and

FIG. 6 is a block diagram illustrating the internal configuration of a known image processor.

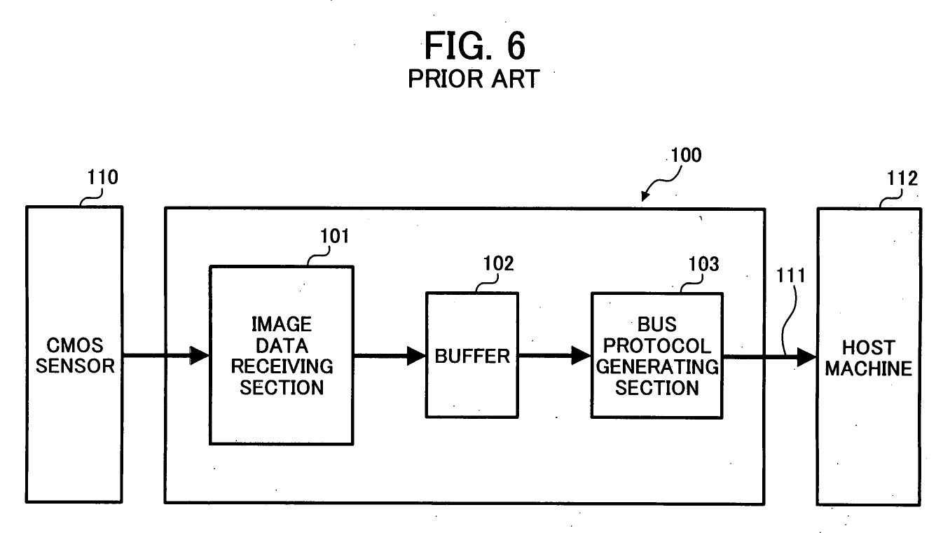

### DETAILED DESCRIPTION OF THE INVENTION

In the detailed description which follows, specific embodiments are described on a semiconductor integrated circuit incorporated into an image processing system, configured to perform image data processing.

It is understood, however, that the present disclosure is not limited to these embodiments. For example, it is appreciated that the present integrated circuit may also be adaptable to a variety of other circuits. Other embodiments will be apparent to those skilled in the art upon reading the following description.

In addition, in the description that follows specific terminology is used in many instances for the sake of clarity. However, the disclosure of this patent specification is not intended to be limited to the specific terminology so selected, and it is to be understood that each specific element includes all technical equivalents that operate in a similar manner.

According to a general example of the present invention, a semiconductor integrated circuit is provided, which is configured to convert input image data according to a predetermined protocol of an output bus and subsequently output the thus converted image data. The semiconductor integrated circuit includes at least a data processing section and a process control section.

The data processing section is configured to perform predetermined processing with respect to the input image data to subsequently output processed image data.

The process control section is configured to control, according to a control signal input from outside, the output process of the processed image data. Namely, in the case when the output process of the processed image data is disabled, the process control section instructs the data processing section to output prefixed image data.

In another aspect, the process control section is provided with an image data storage mechanism to store image data which can be set from outside. In the case when the output process of the processed image data is disabled, it is configured to instruct the data processing section to output image data stored in the image data storage mechanism.

Moreover, the predetermined protocol mentioned above is a USB interface.

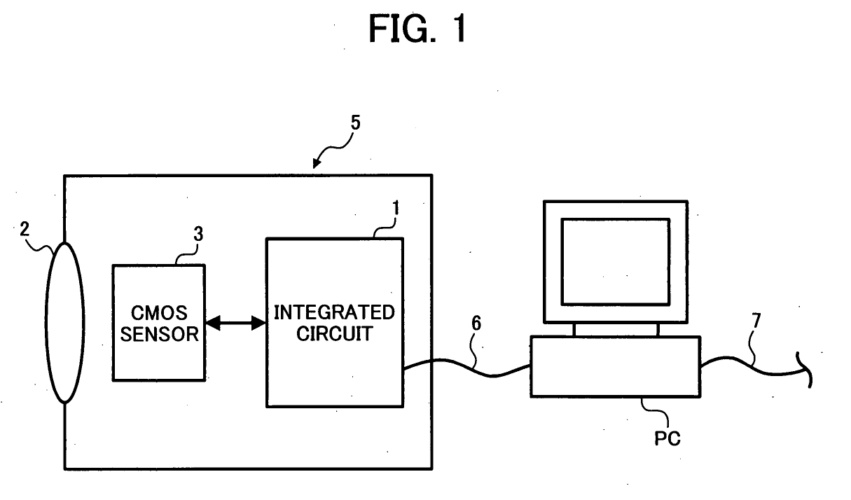

Having described the present invention in general, several preferred embodiments of the integrated circuit will be described below according to the present invention with reference to FIGS. 1 through 4.

FIG. 1 is a diagrammatic block diagram illustrating the configuration of a system, such as an image processing system, incorporating an integrated circuit according to an exemplary embodiment of the invention.

Referring to FIG. 1, the system includes at least a PC serving as a host machine; and a Web camera 5 including an integrated circuit 1 which is connected to a USB interface serving as a host bus, a lens 2, and a CMOS sensor 3, as major components.

The Web camera 5 is connected to the PC by way of a USB interface 6. In addition, the PC is provided with a communications interface 7 configured to establish the connection of the abovementioned system to another system of the party on the other end.

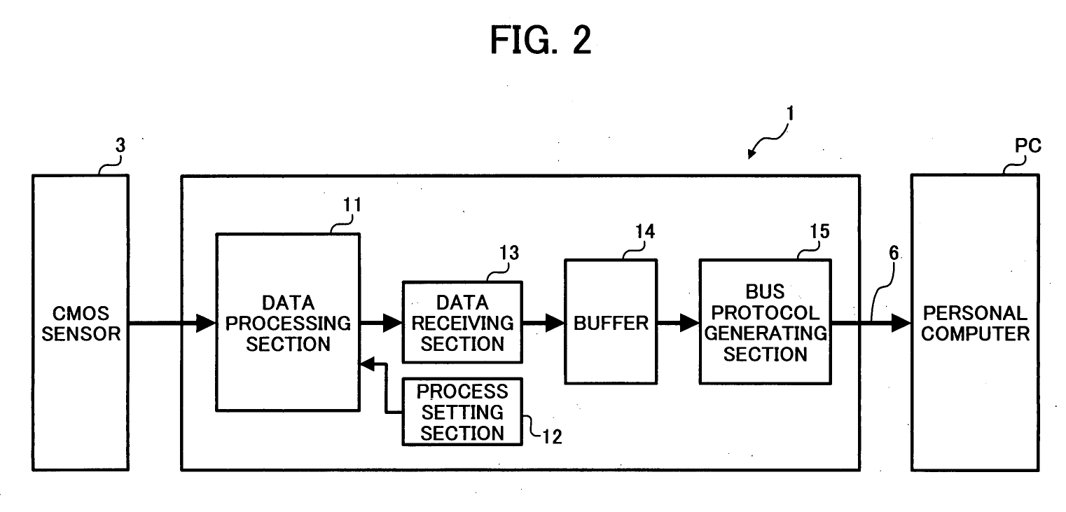

FIG. 2 is a block diagram illustrating the internal configuration of the integrated circuit 1 of FIG. 1.

Referring to FIG. 2, the integrated circuit 1 includes a data processing section 11, a process setting section 12, an image data receiving section 13, a buffer 14, and a bus protocol generating section 15.

Incidentally, the process setting section 12 serves herein as a process control section, and the data processing section 11 is configured to perform a predetermined process with respect to the received data transmitted from the CMOS sensor 3. The process setting section 12 operates to determine, for the data processing section 11: (1) the enabling/disabling of the above mentioned data processing function, and (2) the use/disuse of the input image data received from the CMOS sensor 3.

The image data receiving section 13 is configured to acquire image data from the data processing section 11 according to an interface protocol with the CMOS sensor 3, and subsequently to instruct the buffer 14 to store the thus acquired image data.

The bus protocol generating section 15 is configured to read the image data from the buffer 14, according to a predetermined connection protocol, to be transmitted to the personal computer.

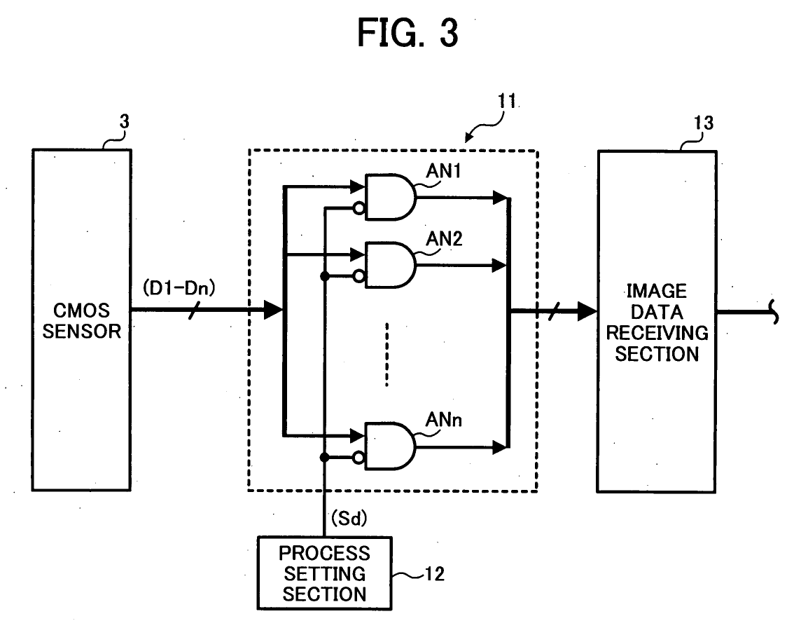

FIG. 3 is a block diagram illustrating the internal configuration of the data processing section 11 of FIG. 1.

Referring to FIG. 3, the data processing section 11 includes n AND circuits, AN1, AN2, . . . , and ANn, where n is a positive integer.

One input terminal of each of the AND circuits AN1 through ANn serves as an inverting input terminal, while the other input terminal serves as a non-inverting input terminal.

The non-inverting input terminals of the AND circuits AN1 through ANn are input with image data D1 through Dn from the CMOS sensor 3, respectively.

The following are examples of setting processes performed by the process setting section 12: (1) a data process setting value Sd is set to be “1” in the case when the data processing function of data processing section 11 is enabled, while (2) the setting value Sd is set to be “0” when the function is disabled.

It should be noted that the setting value Sd may alternatively be set the other way around. That is, the setting value Sd can be set to be “0” when data processing function is enabled, while the value Sd can be set to be “1” when disabled.

By setting the data processing function of data processing section 11 to enabled, image data from CMOS sensor 3 are not utilized and then prefixed image data are transmitted as alternative image data to image data receiving section 13.

In contrast, by disabling the function of data processing section 11, image data from CMOS sensor 3 are transmitted to the image data receiving section 13, which is indicative of the so-called normal processing.

If the data process setting value Sd is “1”, that is, at the level “high”, output terminals of respective AND circuits AN1 through ANn are low. As a result, regardless of image data Dl through Dn input from the CMOS sensor 3, image data DA1 through DAn are generated all containing “0” by data processing section 11 and output to image data receiving section 13.

By contrast, if the data process setting value Sd is “0”, that is, at the level “low”, image data D1 through Dn, which are input correspondingly from the CMOS sensor 3, are output to image data receiving section 13.

On the other hand, in the case when the data processing function by data processing section 11 is enabled as described earlier in reference to FIG. 3, the processing section 11 is configured to output the data all containing n-bit “0”.

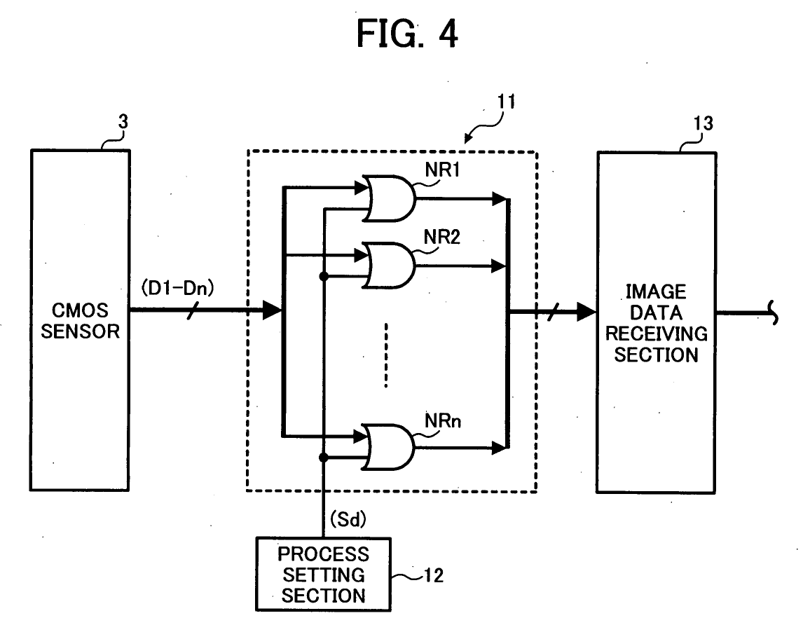

However, the data processing section 11 may alternatively be configured to output the data all containing n-bit “1”, which is illustrated in FIG. 4 in place of the previous illustration with reference to FIG. 3.

The components included in FIG. 4 that are similar to those in FIG. 3 are shown with identical numerical representations, and the description thereof is herein abbreviated for purposes of clarity.

The data processing section 11 of FIG. 4 has a device configuration similar to that of FIG. 3, with the exception that NOR circuits NR1, NR2, . . . , and NRn are included in place of the AND circuits AN1, AN2, . . . , and ANn.

In addition, in the case when the data processing function by data processing section 11 is enabled as described in reference to FIGS. 3 and 4, the processing section 11 is configured to output the data all containing either n-bit “0” or “1”, respectively.

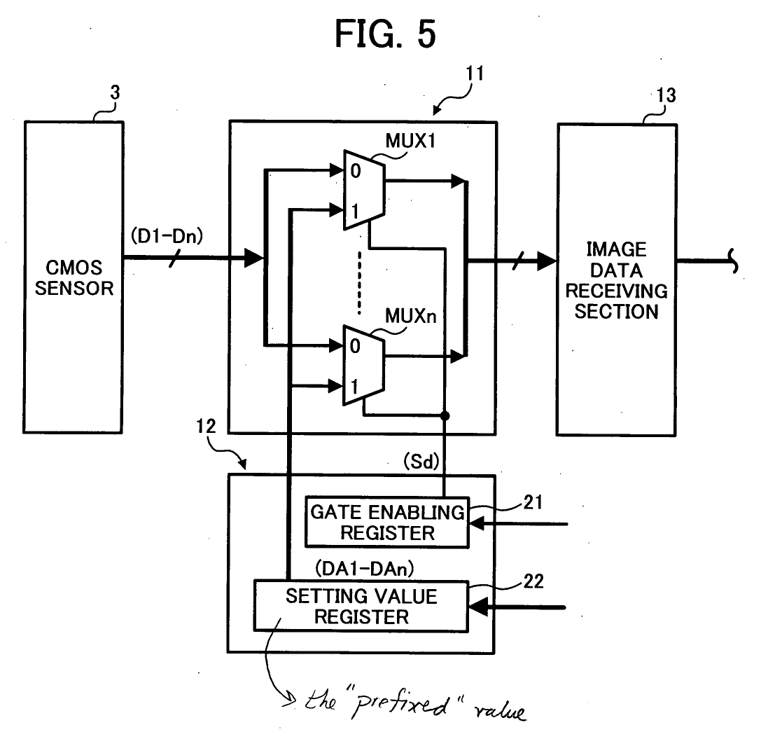

Moreover, the data processing section 11 in the case of enabled data processing function may alternatively be configured to output n-bit data formed by suitably combining “0” and “1” by data processing section 11, which is illustrated in FIG. 5 in place of the previous illustration with reference to FIGS. 3 and 4.

Referring to FIG. 5, the data processing section 11 includes n multiplexers MUX1, MUX2, . . . , and MUXn.

In addition, the process setting section 12 includes a gate enabling register 21 configured to store, at least from outside, the data instructing enabling or disabling of the aforementioned data processing function of data processing section 11; and a setting value register 22 configured to store, at least from outside, n-bit data DA1 through DAn to be output from data processing section 11 when the data processing function by data processing section 11 is enabled.

Incidentally, the setting value register 22 serves as an image data storage means.

One input terminal of each of the multiplexers MUX1, MUX2, . . . , and MUXn is input with image data D1 through Dn from the CMOS sensor 3, respectively, while the other input terminal is input with the abovementioned n-bit data DA1 through DAn stored in the setting value register 22.

When the data “1” for enabling the data processing function by data processing section 11 are stored from outside in the gate enabling register 21, respective multiplexers MUX1, MUX2, . . . , and MUXn operate to output n-bit data DA1 through DAn, which are previously stored in the setting value register 22, to the image data receiving section 13.

By contrast, when the data “0” for disabling the data processing function by data processing section 11 are stored from outside in the gate enabling register 21, respective multiplexers MUX1, MUX2, . . . , and MUXn operate to output n-bit image data D1 through Dn, which are input correspondingly from the CMOS sensor 3, are output to image data receiving section 13.

As a result, a prefixed value can be set by bits of image data with the present device configuration.

In addition, by means of the gate enabling register 21 configured to determine the enabling/disabling of data processing function by data processing section 11 and the setting value register 22 configured to store setting values for respective image data bits, the value of image data bits as well as the setting of the gate enabling register 21 and the setting value register 22 can be changed arbitrarily bit by bit from outside.

Moreover, the setting of the gate enabling register 21 and the setting value register 22 can also be changed arbitrarily from outside.

As described herein above, the integrated circuit of the invention is provided with the additional data processing capability, in that image data acquired by CMOS sensor 3 are transmitted to personal computer not only directly as acquired, but also as prefixed image data as a result of suitable processing, if desired.

As a result, the prefixed image data can be utilized as a substitute for image data which are inappropriate for normal image display.

Such capabilities as mentioned above can be achieved simply by suitably processing and then transmitting image data contents without substantially affecting the basic construction of the present system configuration with respect to hardware as well as software of the personal computer.

It may be added that the means for enabling/disabling the transmission of prefixed pattern data may alternatively be performed by several methods such as, for example, (1) by preparing a further application on the host side and transmitting enabling/disabling instructions to the integrated circuit 1 by way of USB interface 6, and (2) by providing a switch or a similar device on the web camera 5, detecting the state of the switch, and determining enabling/disabling according to the detected state, by the integrated circuit 1.

Moreover, a CMOS sensor is included in the web camera in the abovementioned example, for explanation purposes. However, another device such as, for example, a CCD sensor may alternatively be used.

It is apparent from the above description including the example disclosed that the semiconductor integrated circuit of the invention can offer several advantages over similar power circuits previously known.

For example, the semiconductor integrated circuit includes a data processing section and a process control section which is provided with an image data storage means.

The process setting section is configured to determine the enabling/disabling of the image processing function by the data processing section.

By disabling the image processing function, image data from CMOS sensor are transmitted to the image data receiving section. By enabling the image processing function, in contrast, prefixed image data are transmitted as alternative image data.

With this device configuration image data acquired by a CMOS sensor are transmitted to personal computer not only directly as acquired, but also as prefixed pattern data as a result of suitable processing, which can be utilized, if desired, as a substitute for image data inappropriate for normal image display.

In addition, these process steps can be performed using the semiconductor integrated circuit of the invention without substantially affecting the basic image data process flow and without decreasing the speed of image data processing.

While the invention has been described in conjunction with the preferred embodiments, including specific device configurations and image processing, it is evident that many alternatives and variations will be apparent to those skilled in the art. Accordingly, the preferred embodiments of the invention as set forth herein are intended to be illustrative, not limiting. Various changes may be made without departing from the spirit and scope of the invention as defined in the following claims.

What is claimed as new and desired to be protected by Letters Patent of the United States is:

1. A semiconductor integrated circuit configured to perform at least a first operation of converting input image data to a predetermined protocol of an output bus to form converted image data and a second operation of outputting said converted image data, comprising:
a data processing section configured to perform predetermined processing on said input image data and to output processed image data; and
a process control section configured to control, according to a control signal, said data processing section, including controlling the outputting of said processed image data, wherein
said process control section is configured, in a case when said outputting of said processed image data is disabled, to instruct said data processing section to output prefixed image data.

2. The semiconductor integrated circuit according to claim 1, wherein said process control section further comprises:
an image data storage mechanism configured to store image data, wherein
said process control section is configured, in a case when said outputting of said processed image data is disabled, to instruct said data processing section to output image data stored in said image data storage mechanism.

3. The semiconductor integrated circuit according to claim 1, wherein said predetermined protocol is a USB interface.

4. The semiconductor integrated circuit according to claim 2, wherein said predetermined protocol is a USB interface.

5. A semiconductor integrated circuit configured to perform at least a first operation of converting input image data to a predetermined protocol of an output bus to form converted image data and a second operation of outputting said converted image data, comprising:
data processing means for performing predetermined processing on said input image data and to output processed image data; and
process control means for controlling, according to a control signal, said data processing means, including controlling the outputting of said processed image data, wherein
said process control means, in a case when said outputting of said processed image data is disabled, instructs said data processing means to output prefixed image data.

6. The semiconductor integrated circuit according to claim 5, wherein said process control means further comprises:
image data storage means for storing image data, wherein
said process control means, in a case when said outputting of said processed image data is disabled, instructs said data processing section to output image data stored in said image data storage means.
